(19) United States
(12) Patent Application Publication
(10) Pub. No.: US 2011/0311803 A1
(43) Pub. Date: Dec. 22, 2011

(54) DELAYED-TACK MATERIAL

(75) Inventor: Martin Cockroft, Cumbria (GB)

(73) Assignee: INNOVIA FILMS LIMITED, Wigton, Cumbria (GB)

(21) Appl. No.: 13/147,103

(22) PCT Filed: Mar. 9, 2010
(86) PCT No.: PCT/GB2010/050400

§ 371 Date: Aug. 18, 2011

(30) Foreign Application Priority Data
Mar. 13, 2009 (GB) 0904378.7

(51) Int. Cl. B32B 7/12; B05D 5/10; C09J 131/04; C09J 129/04; C09J 11/06; C09J 133/00

(52) U.S. Cl. 428/323; 524/285; 524/169; 524/293; 427/207.1

(57) ABSTRACT

The present invention concerns a substrate carrying a delayed-tack formulation, wherein said delayed-tack formulation becomes tacky on heat activation to allow sealing between the substrate and itself or between the substrate and a further material, so that the resultant seal can be pealed open mechanically without damaging or destroying said substrate or said further material, and so that said formulation possesses re-tack properties to allow subsequent resealing.

### FIELD

The present invention relates to a delayed-tack material, i.e. a material which possesses adhesive properties after activation. In particular, though not exclusively, the invention is applicable in the fields of packaging and labelling.

### BACKGROUND

Resealable packages utilising “zippers” are known in the packaging field and permit the re-closing of packaging to protect the contents. These are however difficult to use and costly and complex to manufacture.

Packaging for paper reams is known which has an easy open facility with a transversely applied tear (applied at 90° with respect to the machine direction). This enables the wrapping to stay in place once the packaging is opened, but some exposure of the contents is nevertheless unavoidable.

The base material for ream wrap is generally manufactured as sheet or film material before being applied to converters who process it into ream wrap. There is a need for a convenient and cost-effective method of sealing which can be incorporated into the manufacture process. There is also a need for improved labels and methods of labelling.

U.S. Pat. No. 4,833,023 and related document U.S. Pat. No. 4,745,026 disclose a thermal delayed-tack sheet having a coating layer comprising an adhesive polymer, a plasticizer and preferably a tackifier. The sheet is non-tacky at room temperature but on heat activation exhibits tackiness which is retained for a period after the heat source is removed. The heat melts the plasticizer and causes it to solubilise the adhesive polymer thereby providing tack. However, these documents teach that peeling away from the substrate should be avoided. They state that the particle size of the plasticizer is preferably 10 micrometres or less and teach wet pulverization of the plasticizer using for example a homogeniser, a warring blender, a ball mill and an attritor.

U.S. Pat. No. 4,091,162 uses a different mechanism to provide delayed tack properties. It discloses a delayed tack adhesive composition comprising particles which have a soft and tacky polymer core surrounded by a hard and non-tacky polymer shell in admixture with a solid modifier such as a solid plasticiser. No particle sizes of plasticizer are mentioned. On heat activation the plasticizer dissolves the shell and releases the core polymer. This document is particularly concerned with applications at low temperatures, for example deep-freeze temperatures, and applications where labels can not be removed without “fibre tear”, i.e. the breaking apart of the labels or substrate.

U.S. Pat. No. 4,121,956 discloses a method for labelling a package using an ionomer adhesive, of particular use at low temperatures. When the label is pulled from the package, it tears.

U.S. Pat. No. 4,427,744 discloses a heat-activated pressure-sensitive adhesive comprising a rubber, a rosin compound and a plasticizer. Particle sizes are not specified. This document aims to provide adhesion which is strong so that attempted mechanical separation results in substrate tearing.

GB 910,871 and GB 911,821 disclose an adhesive film which is non-tacky at room temperature but which when activated by heat will become usefully adhesive and remain tacky for a while even when cooled to a temperature below the activation temperature. The delayed-action heat-seal adhesive film comprises a potentially viscid material (which is sticky and tenacious on heating) and a plasticiser. Particle sizes are not specified and the documents are concerned with providing strong adhesion.

EP 0 852 614 discloses a delayed tack adhesive composition comprising a thermoplastic polymer or resin, a plasticizer and optionally a tackifier. In order to avoid peeling, this document uses as adhesive component a thermoplastic polymer prepared from a radical-polymerizable monomer having a straight-chain or branched alkyl group having 9 to 18 carbon atoms.

U.S. Pat. No. 5,252,393 discloses a thermal delayed-tack adhesive composition comprising a polymeric resin, a plasticizer and a tackifier. The composition is designed to avoid peeling from a substrate. The composition may be applied as an aqueous resin dispersion containing solids with particle sizes within the range 0.05 to 3 micrometres, preferably 0.05 to 1 micrometre.

U.S. Pat. No. 6,071,611 discloses a sheet for providing an ink-receiving layer and an adhesive layer which may contain a thermoplastic resin and a plasticizer, thereby providing a delayed-tack adhesive. The ink-receiving layer and the adhesive layer may be the same layer. The ink-receiving layer is adhered to any desired receiving material (such as a PVC sheet, a wall or a metal plate) by the adhesive layer. The product is thereby permanently bonded to the desired receiving material. Specific particle sizes are not discussed.

U.S. Pat. No. 5,627,229 discloses a class of hot melt adhesives containing a tackifier, an aromatic plasticiser and optionally a thermoplastic polymer to result in properties which change after application. The adhesive is stated to have excellent wet and dry bond strength. Some products disclosed in this document are peelable, for example removable coupons which can be removed without damage to the coupons, or paperboard which can be separated with no fibre tearing or straining of the adhesive. However, in contrast to delayed-tack materials, this document uses a tackifier as the major component, to impart tack in a non-delayed manner. Tackifier-based compositions are difficult to handle and may tack prematurely.

EP 0 427 792 discloses a hot melt adhesive comprising a polymer, a tackifier and 1,4-cyclohexane dimethanol dibenzoate as plasticiser. This plasticiser is stated to have improved properties, for example by providing high tensile strength and fast set times.

EP 0 989 162 discloses a delayed-tack thermoplastic resin composition containing a thermoplastic resin and a solid plasticiser. A resultant thermal- and pressure-sensitive adhesive sheet can be removed from a substrate by hand. However, this document does not disclose re-tack or the resealing of a substrate. The solid plasticizer preferably has an average particle diameter of approximately 0.5 to 20 microns, more preferably approximately 1 to 15 microns.

GB 1 209 850 discloses a thermoplastic adhesive comprising particles of plasticiser encased in polymeric material for the purpose of evenly incorporating plasticiser into the adhesive and avoiding the grouping of plasticiser particles. Whilst the polymeric coating is made up of polymeric particles which usually range in average size between 0.5 and 2 microns, the particle size of the plasticiser is merely stated as being usually less than 50 microns.

### DETAILED DESCRIPTION

From a first aspect the present invention provides a substrate carrying a delayed-tack formulation, wherein said delayed-tack formulation becomes tacky on heat activation to allow sealing between the substrate and itself or between the substrate and a further material, so that the resultant seal can be pealed open mechanically without damaging or destroying said substrate or said further material, and so that said formulation possesses re-tack properties to allow subsequent resealing.

Thus in this aspect the material is a sealable, peelable, delayed tack material.

Thus “latent” tack properties can be imparted to a material which may be stored, transported and supplied as required, without premature activation of adhesive properties. Application of heat triggers the adhesive properties at a convenient time and place dependant on end use. For example, the material may be carried on a film which is intended to be wrapped around an object for protective, decorative or other purposes, and the film may then be sealed to itself via the adhesive composition during an enveloping process, to enclose the object (for example a ream of paper).

In some applications a reseal function is not necessary. In yet further applications a pealable function is not necessary. The present invention is compatible and flexible to allow suitability for various applications, according to the following further aspects. The optional preferences described herein apply mutatis mutandis with respect to the following additional aspects of the present invention.

In one further aspect the present invention provides a substrate carrying a delayed-tack formulation, wherein said delayed-tack formulation becomes tacky on heat activation to allow sealing between the substrate and itself or between the substrate and a further material, so that the resultant seal can be pealed open mechanically without damaging or destroying said substrate or said further material, wherein said delayed-tack formulation comprises an adhesive polymer and a plasticiser, said plasticiser being in the form of particles with an average size of less than 0.5 micrometres.

In another further aspect the present invention provides a delayed-tack formulation, wherein said delayed-tack formulation becomes tacky on heat activation, comprising an adhesive polymer and a plasticiser with a softening point of at least 80° C.

In another further aspect the present invention provides a delayed-tack formulation, wherein said delayed-tack formulation becomes tacky on heat activation, comprising an adhesive polymer and a plasticiser in the form of particles with an average particle size less than 1 micrometre.

In another further aspect the present invention provides a delayed-tack formulation, wherein said delayed-tack formulation becomes tacky on heat activation, comprising an adhesive polymer and a plasticiser in the form of particles with an average particle size less than 1 micrometer, said plasticizer having a softening point of at least 80° C.

The delayed-tack formulations may be carried on substrates to result not only in packaging which may be sealed to itself or other substances, but also in articles which possess adhesive properties for labelling or other purposes.

It is extremely useful not only to be able to mechanically separate (i.e. usually by hand) a package but also reseal it mechanically, so that the package is not only undamaged but also retains the ability to repackage and reprotect the remaining contents.

Only that part of the delayed-tack formulation which is heated becomes tacky, so the versatility of the product is enhanced. Of course, in many cases it may be preferred for reasons of cost and/or convenience to only apply the delayed-tack material where tack will subsequently be required.

The substrate may for example be a film. In this specification, the word “film” is used to denote a sheet material which may be used in a variety of applications, including but not limited to applications in the form of labels or graphic arts vehicles, wrapping or packaging materials. The films of the invention are generally sheet-form materials, and may be provided as individual sheets, or as a web material which may subsequently be processed (by die cutting for example) to provide sheet or article form materials. When referring to “film” in this specification it is intended, unless expressly provided otherwise, to include films in sheet, article or in web form.

The films of the invention are generally, though not essentially, polymeric films. Preferred types of film in accordance with the invention are polypropylene and other polyolefin films for applications such as packaging, labels and overwrap. Other types of film are however possible, such as for example polyesters, polyamides and biopolymers such as cellulose and derivatives thereof, PLA and other starch-based materials. A preferred film is polypropylene, for example oriented polypropylene (OPP). Films of the invention may be mono-web, or laminated.

The delayed-tack properties make the present invention extremely suitable for use in films which are sold or transported in rolled-up form, because the film does not stick to itself despite the absence of release liners or layers; the adhesive property is latent during rolling up, storage, transportation and unwinding, and requires heat activation to appear.

The tack strength is preferably 50 to 600 g/25 mm2. For example the tack strength may be 100 to 300 g/25 mm2. When used in seal/reseal coatings in resealable packaging such as for example ream wrap or dried pasta bags, the package is peelable and resealable several times, but the tack strength does not need to be very high.

The formulation may be used as a PSA-type coating where it sticks well to one of the variety of surfaces, for example, glass, metal or plastic.

A further application is a de-activatable coating. This utilises a secondary activation temperature to “kill” the tack so that for example adhesive properties are removed when required.

Preferably the delayed-tack formulation comprises an adhesive polymer and a plasticiser. The coating is non-blocking at room temperature but becomes tacky once activated, when heated to the softening temperature of the plasticiser, and remains tacky for a desired period of time. Such coating is especially useful on labels and in sealing packages, such as ream wrap packages, for example.

A plasticiser or softener is a substance or material incorporated into a polymer to increase its flexibility, workability, or distensibility.

Without wishing to be bound by theory, it is believed that the compatible plasticiser enters the polymer matrix and embeds itself between the polymer chains thereby increasing the free volume of the polymer through free rotation of the plasticiser and decreasing the Tg (glass transition temperature) of the polymer. This means that the polymer chains are more mobile and can therefore line up at the surface to achieve the most effective interactions (for example hydrogen bonds) to produce tack properties.

The effect of the present invention is thus enhanced by compatibility between plasticiser and polymer. Preferably the plasticiser forms a homogeneous system with the polymer.

Plasticisers are believed to aid disassociation of interacting functional groups (e.g. polar and hydrogen bonding groups), in the amorphous regions of the polymer, in effect dissolving selected parts of the polymer.

Adhesive polymers possess adhesive properties i.e. tack, by virtue of substituents which can effectively interact with each other e.g. through hydrogen bonding or dipole attractions. These types of polymers usually contain polar groups which tend to encourage a higher Tg (glass transition temperature) than non-polar groups of a similar size. Polymers can achieve tack at room temperature if they have a glass transition temperature of room temperature or below and this may be achieved by the addition of a compatible plasticiser. This is so the polymer is in the rubbery state at room temperature allowing the polymer chain to be mobile. The polymer chains can align at the surface and can achieve “tack” if the polymer contains complementary substituents so it can interact with itself.

The polymer may for example be an acrylic polymer, polyvinyl adhesive, vinyl acetate or polyvinyl alcohol, though the invention is generally applicable to adhesive polymers. Some specific examples of suitable adhesive polymers include those sold under the trade mark “Revacryl” (e.g. Revacryl 480 or Revacryl 1A) or sold as Emultex VV665 by Synthomer Limited, Harlow, Great Britain; or Mowilith DC, Mowilith DM230 and Vancryl 1825 sold by Mowilith Celanese (Celanese Emulsions Slovenia AG c/o Celanese Emulsions GmbH, Frankfurt am Main, Germany).

Preferably the plasticiser and the adhesive polymer are thoroughly dispersed in each other to form a composition which is thoroughly blended to enhance adhesive and optical properties after activation.

The adhesive polymer prior to activation is relatively hard and non-tacky, but tack arises when the composition is heat activated with a softening plasticiser.

Optionally the delayed tack coating comprises a tackifier to further enhance tack strength. A tackifier is a substance, for example a resin, which possesses tack properties without needing activation. Tackifiers increase the number of tack sites at the surface and thus provide additional adhesion over and above that provided by the polymer-polymer interactions. If necessary the tack of the tackifier may be “masked” for example by coating in wax or other material which releases the tackifier at an appropriate temperature, for example 80° C.-100° C. Encapsulation in wax prevents blocking until the melting point of the wax is reached.

However it is an advantage according to the present invention for the formulation to be essentially free from tackifier or contain only a small amount of tackifier; it has been found that the mere combination of plasticiser and adhesive polymer is effective. Use of no tackifier is advantageous in reducing cost, complexity and easing handling and manufacture.

The delayed tack coating formulation optionally also comprises a liquid carrier (for example water or other fluid) to enhance workability and enable it to be applied to a substrate more easily, for example by coating.

Preferably the plasticiser has a low particle size. After extensive work this has been shown by the present inventors to improve optical properties, increase tack strength, prolong tack lifetime and reduce activation times. For example, plasticiser may have particles of size less than about 3 micrometres, less than about 1.5 micrometres, less than about one micrometer, less than 0.5 micrometres or less than about 0.3 micrometres.

It is believed that larger particles scatter light more to result in a poorer optical appearance. Furthermore the use of larger particles means that there are fewer particles in the coating and a greater distance between plasticiser particles; therefore more time is believed to be required for the plasticiser to diffuse to produce a homogenous polymer blend on activation.

In contrast, smaller plasticiser particles scatter light less, giving a better optical appearance. Furthermore, the use of smaller particles means that there can be more of them in the coating. This reduces the distance between the particles which is believed to increase the surface area for topochemical diffusion of the plasticiser, thereby reducing the time taken for the plasticiser to diffuse to produce a homogenous polymer blend.

Smaller particle size means that more effective polymer-plasticiser interactions can occur at the activation stage.

The activation temperature is chosen dependant on use, environment and other considerations such as storage, transportation, environmental and climate conditions. To avoid premature tack the softening temperature of the plasticiser is preferably greater than room temperature, preferably greater than 40 degrees centigrade, more preferably greater than 60 degrees centigrade. A softening temperature greater than 70 degrees centigrade, for example greater than 80 degrees centigrade, or greater than 90 degrees centigrade may optionally be chosen, in accordance with any aspect of the present invention. A high melting point plasticiser avoids problems during manufacture and transportation due to blocking, especially in environments where the temperature is higher. For example, it is advantageous to prevent blocking of reels of film.

One possible plasticiser which is commonly and cheaply available and compatible with a range of adhesive polymers is DCHP (dicylohexyl phthalate) and this may be used as the plasticiser in accordance with the present invention. Other examples of plasticisers which may be used in accordance with the present invention include, but are not limited to, K9S (p.o-toluene sulphonamide) and Benzoflex (1,4-cyclohexyl dimethanol dibenzoate), GTB (glycerol tribenzoate), PETB (pentaerythritol tetrabenzoate), and plasticisers of related structure and chemical functionality, for example as available from supplier Aquaspersions Ltd. (UK), Halifax, England.

The effect of the invention is enhanced by the polymer being compatible with the plasticiser. The polymer contains suitable functional groups (for example polar groups or groups for hydrogen bonding) to achieve tack properties, and also possesses a sufficiently high Tg value to avoid premature blocking.

The invention allows production of a delayed tack coating for e.g. polypropylene (PP) films, which is block-free at room temperature allowing the film to be wound onto a reel and transported without blocking. On heating, the coating becomes tacky and behaves as an adhesive and remains tacky for a long period of time, even after the heat source is removed and the coating has returned to ambient temperature.

The coated film possesses an activation temperature high enough so it can be manufactured and transported without blocking. As coatings for PP films are usually water based the coating needs to be able to withstand a high enough temperature to allow the coating to be dried without activating. The temperature required depends on the drying method and water system used. Furthermore the coating needs to be able to withstand any further conversion process and transportation to countries where it may be subjected to high temperatures.

The coating is useful for a variety of uses of which the following are examples. For re-sealable packaging, such as re-sealable bags or re-sealable ream wrap, the coating is peelable and resealable without severe loss of tack strength, to allow repeated resealing. Preferably the coating is able to remain tacky over a long period of time when exposed to air. The coating optionally may be applied only in the sealing area, in which case the optics of the coating are relatively unimportant. If the coating is applied all over the film then it is more desirable for the coating to possess good optical properties, e.g. appropriate haze and gloss values. Such films remove the need for sticky labels to be applied to the opening area of packets or bags for re-sealability. In many cases the process of applying such labels is more costly than the rest of the packaging.

The coated film is also useful in label applications where the coating needs to adhere to one of a variety of different substrates including glass, polyethylene and a range of metals. A long tack lifetime is desirable but optics are less important. This is because the coating is acting as an adhesive and as such is sandwiched between the outer film and the substrate which it is stuck to. As a result of the delayed tack properties of the present invention, a lamination stage, which is usually present in a label production process, may be dispensed with. This is where an adhesive is applied to the film and then a release liner is applied to enable the film to be reeled up; this is a costly process which also produces a large amount of waste material. In accordance with the present invention no release liner is required; this reduces cost and environmental impact.

In another application the coated films can be used to replace the adhesive used in the lamination process thereby making lamination quicker, cleaner and less energy intensive.

In cases where the coating may come into contact with food, healthcare or other similar materials, the chemicals used are appropriate and safe.

In a further aspect the present invention provides a method of preparing a substrate carrying a delayed-tack formulation as defined above, comprising forming an emulsion of a plasticiser and an adhesive polymer, coating said substrate with said emulsion, and drying the resultant coating below the tack activation temperature.

The formulation may be applied by any means for example by coating or co-extrusion, though coating is preferred because it is convenient to apply the composition as a solvent-based or water-based material.

After application the formulation is dried by a process which does not cause premature activation. The drying method does not heat the formulation to the activation temperature. Examples of drying processes include air flotation, microwave drying or infrared drying.

Whilst in many cases the composition will be used to coat one side of a substrate, e.g. one side of a film, there can optionally be other coatings (e.g. acrylic coatings) on both sides of the film for sealability or other purposes.

A typical protocol and mechanism for preparation and use of a delayed-tack coating according to the present invention is as follows:

Disperse finely ground solid plasticiser particles in a polymer emulsion to produce the coating formulation.

Apply this dispersion to the film as a coating.

Dry the wet coating below the softening point of the plasticiser to prevent the plasticiser from softening. This is believed to prevent diffusion of the plasticiser into the polymer and avoid polymer-plasticiser interactions.

Activate the coating by heating to a temperature above the softening temperature of the plasticiser. This causes the plasticiser to disperse in the polymer to result in a plasticised homogenous solution and create a tacky material. The softening of the plasticiser is believed to increase the free volume between the polymer chains, decrease the glass transition temperature of the polymer and increase the mobility of the polymer chains.

Adhere plasticised, polymeric, tacky surface to desired material. The tack is achieved by favourable polymer interactions at the surface of the coating, for example hydrogen bonding and dipolar forces.

A plasticiser may be incorporated into a polymer and retained by it without exudation during storage up to its “limit of compatibility”.

The major factors that determine the compatibility between polymers and plasticisers are the chemical structure and the polarity of the molecules. If the bonds contained within the polymer chains and in the plasticiser molecules are similar in polarity, then in effect a solution may be formed. Similar polarities, shapes or solubility parameters aid interaction; in brief, “like dissolves like”. However if the polymer-polymer interaction or the plasticiser-plasticiser interaction is more energetically favourable than the polymer plasticiser interaction then there is a higher probability of polymer or plasticiser agglomeration.

A capacity for the plasticiser to bond itself, for example by internal hydrogen bonding, may cause plasticiser-plasticiser interactions to be preferred over plasticiser-polymer interactions thereby decreasing compatibility.

The chemical structure of the plasticiser affects its plasticising ability and compatibility with the polymer. Polar and polarisable groups in a plasticiser, for example carboxylic acids and benzene rings respectively, can increase the strength of the polymer-plasticiser interactions. However these groups may only moderately improve flexibility if there are numerous such polymer-plasticiser interactions along the polymer chain. The additional presence of non-polar and non-polarisable substituents, for example cyclohexane, to separate the polymer dipoles without introducing intermediate links, may increase flexibility and compatibility.

The free volume, (Vf), is the unoccupied space in a polymer sample, arising from the inefficient packing of disordered chains in the amorphous regions.

The free volume is a measure of the space available for the polymer to undergo rotation and translation within amorphous regions. Plasticiser molecules bind to the polymer in the amorphous regions through various interactions, for example hydrogen bonding or dipole interactions, which aid the dissociation of the polymer chains. This permits increased motion and more flexibility of the polymer molecules. A branched plasticiser is more efficient at increasing the free volume than a linear one of the same weight.

Plasticisation can be treated as a mechanism of increasing free volume. The flexibility and free volume of a polymer sample will to a certain extent depend on the motions of chain ends, side chains and the main chain itself.

These motions, and therefore the free volume of a polymer may be increased by one or more of the following: increasing the number of end groups (for example by using smaller polymers); increasing the number or length of side chains (so-called internal plasticisation); increasing the extent of main chain movement by inclusion of segments of low steric hindrance and low inter- and/or intramolecular attraction (another form of internal plasticisation); inclusion of a compatible plasticiser; and raising the temperature.

When the polymer is in the rubbery state the amount of free volume will increase with temperature as the molecular motion increases. If the temperature is decreased, the amount of free volume will decrease and eventually reach a critical value when there is insufficient free space to allow chain mobility (the glass transition temperature, Tg). Below Tg the free volume will remain constant even if the temperature decreases further since the chains are effectively stationary.

Below Tg the physical properties of the amorphous regions of the polymer vary in a manner similar to those of a solid phase in the so-called glassy state. Above Tg the materials behave more like liquids in the so-called rubbery state.

Below Tg the available thermal energy is insufficient to overcome the rotational energy barriers in the chain, and the chains become locked in whichever conformation they possessed when Tg was reached.

As noted above the Tg depends largely on the amount of thermal energy required to keep the polymer chains moving and a number of factors influence this ability including chain flexibility, molecular structure, molar mass, branching and crosslinking.

The flexibility of the chain is an important factor influencing Tg. It is a measure of the ability of a polymer chain to rotate about the constituent chain bonds. Thus, a flexible chain has a low Tg whereas a rigid chain has a high Tg. The Tg can be increased by the addition of groups (e.g. aromatic groups) which stiffen the main chain by restricting rotation, so that more thermal energy is required to enable the chains to become mobile.

Bulky side chain substituents may hinder the rotation of the polymer backbone and cause the Tg to increase. For example, an increase in steric hindrance can be achieved by substituting a proton with an α-methyl group; the difference in Tg between poly(methyl methacrylate) and poly(methyl acrylate) is 100K.

As the molar mass of a sample is decreased the Tg is essentially lowered. An increased number of chain ends increases free volume resulting in a lower Tg.

As crosslinking increases, the mobility of the polymer decreases. Additionally, secondary bonding due to for example dipole forces, induction forces, dispersion forces or hydrogen bonding between chains decreases the mobility of the polymer, leading to an increase in the Tg.

In the present invention the effect of the compatibility between polymer and plasticiser overrides the polymer-polymer and plasticiser-plasticiser interactions to the extent that good solubilisation, dispersion and latent tack properties are provided. Furthermore, the relative incompatibility of the components of the formulation to the substrate or other material to which the seal is made, means that the product can be peeled without causing damage.

The coat weight is preferably 0.5 to 10 gsm (grams of solid material per square metre), more preferably 1 to 8 gsm, more preferably 2 to 6 gsm, for example about 3 or about 5 gsm.

The solids content in the formulation before application to the substrate is conveniently 10 to 60%, preferably 20 to 50%, for example approximately 30%.

The dried formulation preferably contains, by weight, at least 20% plasticiser, more preferably at least 30% plasticiser or at least 40% plasticiser.

The dried formulation preferably contains, by weight, at least 30% adhesive polymer, more preferably at least 40% adhesive polymer or at least 50% adhesive polymer.

Thus it can be seen that the present invention relates to a formulation which contains, as major ingredients, an adhesive polymer and a plasticiser, and thereby possesses delayed tack properties.

The tackifier is an optional ingredient. The dried formulation preferably contains, by weight, no more than 30% tackifier, more preferably no more than 20% tackifier, no more than 10% tackifier, no more than 2% tackifier, no more than 1% tackifier, or is free from tackifier. As noted above all aspects of the present invention may be such that there is no tackifier present, or only a small amount.

Other ingredients may optionally be present, for example a masking agent for the optional tackifier, a surfactant, and an anti-agglomeration agent to help avoid excessive agglomeration.

The film substrate may comprise a polyolefin film, for example polyethylene, polypropylene, mixtures thereof, and/or other known polyolefins. The polymeric film can be made by any process known in the art, including, but not limited to, cast sheet, cast film and blown film. The film or sheet may be of monolayer or of multi-layer construction. This invention may be particularly applicable to films comprising cavitated or non-cavitated polypropylene films, with a polypropylene core and skin layers with a thickness substantially below that of the core layer and formed for example from co-polymers of ethylene and propylene or terpolymers of propylene, ethylene and butylene. The film may comprise a biaxially orientated polypropylene (BOPP) film, which may be prepared as balanced films using substantially equal machine direction and transverse direction stretch ratios, or can be unbalanced, where the film is significantly more orientated in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

Alternatively, the film substrate may comprise a polyester film, a polyamide film, or an acetate film, for example.

The films used in accordance with the present invention can be of a variety of thicknesses according to the application requirements. For example they can be from about 10 to about 240 μm thick and preferably from about 40 to about 120 μm thick.

The coated film of the invention is suitably manufactured by means of a coating dispersion applied to a film substrate. The dispersion used to coat the substrate should contain about 15-70% solids, preferably 20-60% solids, more preferably 25 to 50% solids, in order to achieve satisfactory film forming properties. The film formed should be uniform and continuous.

The dispersion may be coated onto the surface of the chosen web and dried using any suitable conventional technique. The coating composition of the invention can be applied by any other number of well known techniques, such as dip coating, rod coating, blade coating, air knife coating, gravure coating and reverse roll coating, extrusion coating, slide coating, curtain coating, and the like. After coating, the layer is generally dried by simple evaporation, which may be accelerated by known techniques such as convection heating. The dispersion is preferably applied using a gravure process, and the drying step carried out in an oven. The drying of the coated dispersion removes water from the dispersion leaving a uniform continuous film with any non-film forming particles dispersed in the film.

The film coating composition may be selected to adhere directly to the polymer film substrate, or such adhesion may be promoted by treating the film prior to coating, by corona discharge treatment for example. In some cases it may be preferable to include a primer layer between the film substrate and the coating.

In the coated film of the invention, the coat weight is from about 1.2 g.m-2 to about 20 g.m-2 are contemplated, preferably from about 2.5 g.m-2 to about 15 g.m-2, more preferably from about 3 g.m-2 to about 10 g.m-2, most preferably from about 4 g.m-2 to about 8 g.m-2.

The coated surface of the film may comprise additional materials such as anti-block additives, opacifiers, fillers, UV absorbers, cross-linkers, colourants and the like.

The invention will now be described in more detail by the following examples which are non-limiting.

### Example 1

Delayed tack formulations were prepared using Vancryl polymer 825 and DCHP in emulsions. They were coated onto an A4 sample of C58 polypropylene film, which had been primed using mica primer, using an air driven draw-down coating machine. The coatings were dried using a hand held hair drier.

The samples were then taken and cut into two half and placed onto each other so that a coated side to coated side heat seal could be formed. The seals were made using a heat seal machine at a pressure of 15 psi and a seal time of 2 secs. Seals were done at varying temperatures on the top seal jaw with the bottom seal jaw being kept at 30° C.; the seal top jaw temperatures ranged from 50-120° C. in 10° C. increments.

In one experiment the DCHP was untreated; in another the DCHP was milled prior to incorporation into the emulsion.

As regards seal strength, the following results were obtained.

| | Seal Temp (° C.) | | | | | | | |
|---|---|---|---|---|---|---|---|---|
| | 0 | 0 | 0 | 0 | 0 | 00 | 10 | 20 |
| | Heat Seal Threshold (seal strength in g/ | | | | | | | |
| Sample | 25 mm2) | | | | | | | |
| DCHP Untreated | | | 3 | 8 | 0 | 8 | 9 | 8 |
| (formulated) | | | | | | | | |
| DCHP Milled | | | 0 | 8 | 2 | 3 | 7 | 3 |
| (formulated) | | | | | | | | |

As regards film appearance, the following results were obtained: The film coated with the untreated DCHP emulsion was very hazy and it was clear to see that there were some large white spaces of DCHP on the surface of the coating. The Milled DCHP coated sample was slightly less hazy and had none of the larger white specs on the surface.

In summary the milled DCHP performed better than the unmilled DCHP.

### Example 2

Samples of DCHP were produced in a range of particle sizes and incorporated into coatings.

In initial tests each sample was characterised and formulated to give the same ratio of DCHP to polymer and the same total solids content. For this investigation a ratio of 1:1 DCHP: polymer was used and the total solids content was 30%.

In subsequent testing the coatings were formulated and films coated to give a coat weight of 2 gsm using a red No. 2 K-Bar on a laboratory draw down machine. These films were then tested for the following:

1. Optical appearance of the coated film surface using haze and gloss as a measure.

2. Time taken for re-crystallisation of DCHP after activation.

3. Heat seal threshold or tack at various temps (to decipher minimum activation requirements to see if particle size affects activation time and temperature).

4. Tack strength over a period of time by seal pulling to see if lifetime of tack is affected by particle size.

5. Activation and application to a given surface (e.g. a bottle as a label) to see if once activated and stuck to the surface whether the tack will degrade or the film will permanently adhere to the surface.

6. Number of peel/reseal folds that can be made without severe loss of tack.

Sample Characterisation:

| | | Mean particle | Solids |
|---|---|---|---|
| Sample | Source | size (μm) | (%) |
| 1 | Buhler 2.2 | 0.97 | 53.5 |
| 2 | Buhler 3.1 | 1.15 | 54.5 |
| 3 | Aqua. Superfine | 2.16 | 53.5 |
| 4 | Aqua. Normal | 6.43 | 54.2 |
| 5 | Buhler K8 (80 mins) | 7.44 | 54.5 |

Coating Formulations with Revacryl 480:

| | Rev 480 | DCHP | Water |
|---|---|---|---|
| Sample | (g) | (g) | (g) |
| A | 15 | 14.03 | 20.97 |
| B | 15 | 13.76 | 21.24 |
| C | 15 | 14.03 | 20.97 |
| D | 15 | 13.83 | 21.17 |
| E | 15 | 13.76 | 21.24 |

Coated Film Testing:

1. Optical Properties

Using the haze-gard optical testing machine the films coated film were tested for wide angle haze and clarity; the gloss was tested using the 45° and 60° C. gloss meter and the narrow angle haze was also measured.

The results are shown in the following table

| | Gloss | | Clarity | Gloss | |
|---|---|---|---|---|---|
| Sample | (45°) | WAH | (%) | (60°) | NAH |
| A | 15 | 61.5 | 93.7 | 26 | 4 |
| B | 9 | 77.4 | 86.3 | 19 | 7-9 |
| C | 8 | 85.6 | 71 | 12 | 7 |
| D | 10.5 | 71 | 72.6 | 17 | 15-17 |
| E | 22 | 59 | 68 | 23 | 18-19 |
| Rev 480(*) | 79 | 5.59 | 95.2 | 120 | NA |

(*)To compare these results the Revacryl 480 polymer was also coated onto A4 piece of C50 and tested.

For all of the different optical tests performed it was clear to see that as the particle size is reduced the optical properties are improved. In some cases at the very low particle sizes the improvement was noticeably drastic. The results suggest that reducing the particle size further still would have a very positive effect.

Tack Properties

As particle size increased, it was found to be more difficult to form a well dispersed mixture, and the DCHP recrystallised more rapidly. The seal strength was found to be higher at low particle sizes. The smaller particles appear to require milder conditions in order to achieve a molten state and thereafter good tack. Furthermore, tack strength was retained for longer with smaller particles.

The formulations were found to stick well to glass and metal.

### Example 3

In this example, DCHP was used as plasticiser and Revacryl 480 as adhesive.

DCHP particle sizes of less than 1 micrometre were tested. By further reducing particle size, optical properties were further improved.

A surfactant was added to stabilise the plasticiser particles, help prevent agglomeration, and enhance tack strength in some cases.

It was found possible to use up to 50% DCHP (dry weight %) and achieve an effective seal.

### Example 4

Formulations in this example contained DCHP as plasticiser. When used in combination with Revacryl 480 (an adhesive polymer based on butyl acrylate and methacrylic acid) on a polypropylene film and conventional mica primer the composition was very tacky one activated, produced a very clear coating, provided good re-tack to itself and to other materials, and exhibited good peal and reseal.

A solution of Revacryl 480 and DCHP was formulated, to give a total 30% solids content in water. The solution was made up to contain 30% solid content as this ratio was found to provide the optimum viscosity of the coating, i.e. a balance between the ability of the solution to flow and to achieve high coat weights in order to generate a high level of “tack”. The solution was also made up to possess a 50/50 dry composition of polymer/plasticiser as this ratio gave the strongest “tack” on activation of the coating. The solution was mixed together using a high shear mixer at a speed of 14,000 rpm for 3 minutes to break up agglomerates and to ensure the particles were evenly dispersed throughout the solution.

The solution was then used to perform draw downs on A4 sheets of Polypropylene film. First the yellow K-bar was used to draw down the mica primer onto the film (coat weight=0.1 g/m2). The primer was used to aid the adhesion of the coating to the polypropylene film. The film was then dried and the green K-bar was used to draw down the solution onto the dried mica primer (coat weight=4.0 g/m2). The solution was then dried on the film. A 10 cm×10 cm piece of the coated film was placed in the oven for 60 seconds at 65° C. to activate the plasticiser and hence the tackiness of the coating. The level of “tack” was tested by repeated pealing and sealing to itself and to a glass window.

The solution was white and aqueous on mixing and produced an even but cloudy coating on the film after the draw down was dried.

The solution was very “tacky” once activated and produced a very clear coating. The coating had very good re-tack abilities to itself and other materials including glass. On repeated pealing and sealing, the coating separated with an even distribution indicating effective compatibly between the polymer and the plasticiser.

This was interpreted as follows. The solution contains low molecular weight compounds with similar solubility parameters between the polymer and the plasticiser. Revacryl 480 is a co-polymer containing butyl acrylate and methacrylic acid and therefore contains ester and carboxylic acid groups bound to the carbon back bone making hydrogen bonding is likely. DCHP contains esters attached to a benzene ring making the carbonyl group suitable for effective hydrogen bonds to the polymer i.e. to the carboxylic acid. DCHP also contains two cyclohexane groups attached to the ester groups increasing the free space and therefore increasing the fractional free volume, through free rotation of the molecule. This means the polymer molecules can move past each other even at lower temperatures due to the formation of a homogeneous solution through many effective polymer-plasticiser interactions, indicating high compatibility.

It is evident that Revacryl 480 can be plasticised by DCHP to produce an effective “delayed tack” with efficient re-tack. The activation temperature of DCHP is approximately 63° C.

### Example 5

Instead of DCHP, other plasticisers were used in combination with Revacryl 480 adhesive polymer.

The plasticisers K9S (containing ortho- and para-toluene sulphonamide) and Benzoflex (containing 1,4-cyclohexane dimethanol dibenzoate) were found to result in formulations having appropriate delayed-tack properties.

These plasticisers have the advantage of exhibiting higher softening points (approximately 100 and 118 degrees centigrade for K9S and Benzoflex respectively) thereby preventing premature activation under working, storage and transportation conditions in warm climates or environments.

### Example 6

In place of DCHP, various polymers were tested to assess whether they could be suitable as the adhesive polymer component in a delayed-tack formulation. In this preliminary experiment, polymers were selected if they were non-tacky on drying to room temperature. Revacryl 815, Mowilith LDM 7416, Mowilith DC and Mowilith DM230 were elected on this basis.

### Example 7

The adhesive polymers Mowilith DC (vinyl acetate based) and Mowilith DM230 (containing vinyl acetate and versatic acid vinyl ester) were found to provide effective delayed-tack formulations with the plasticisers K9S and Benzoflex.

### Example 8

Further adhesive polymers were investigated. Revacryl 1A (an acrylic polymer) and Emultex VV665 (contain acryl groups, vinyl acetate and the vinyl ester of versatic acid) were found effective, particularly in combination with the plasticiser K9S.

### Example 9

K9S was used as plasticiser and the effect of reducing particle size observed. In place of the previously used 1 micrometre particle size material, a 0.5 micrometre particle size material was used. Even though agglomeration took place, to result in particles of size 4.4 micrometres, improvements were seen.

The lower particle size material enhanced tack strength.

The plasticiser K9S worked particularly well in combination with the adhesive polymers Revacryl 480, Mowilith DC, Mowilith DM230, Revacryl 1A and Emultex VV665.

The additional presence of a tackifier (Hyvis 600) resulted in a slight increase in tack strength.

Without wishing to be bound by theory, in general the compatibility of polymers and plasticisers can be summarised by the phrase “like dissolves like”. Solubility parameters which are close will often indicate greater compatibility.

Components of the polymer which are more preferred include vinyl acetate, VeoVA (vinyl ester of versatic acid), methacrylic acid ester, acrylic moieties, methacrylic acid and butyl acrylate, for example. Components of the polymer which are less preferred include for example styrene and ethylene moieties and ethylene acrylic acid (due to the adverse influence of ethylene groups overriding the beneficial effects of the acrylic acid parts).

Preferably the plasticiser contains one or more polar group, such as for example NH2, OH, C═O, RCO2H, S═O, RCO2R′ etc. Ability to hydrogen bond is advantageous. Preferably non-polar groups are also present to increase the free volume, such as for example aliphatic groups, cyclohexane moieties, etc.

K9S, containing p-toluene sulphonamide and o-toluene sulphonamide, contains polar groups and exhibits restricted rotation. Benzoflex (1,4-cyclohexyl dimethanol dibenzoate) exhibits poor flexibility and low plasticising effect, packing well into the polymer and not significantly increasing the free volume. DCHP (dicyclohexyl phthalate) exhibits strong H bonding and free rotation of the backbone, leading to an increase in free volume.

1. A delayed-tack formulation, wherein said delayed-tack formulation becomes tacky on heat activation, comprising an adhesive polymer and a plasticiser in the form of particles with an average particle size less than 3 micrometres.

2. The delayed-tack formulation according to claim 1, said plasticizer having a softening point of at least 60° C.

3. The delayed-tack formulation according to claim 1, wherein the average particle size of the plasticiser is less than 1 micrometre.

4. The delayed-tack formulation according to claim 1 further comprising a tackifier.

5. The delayed-tack formulation according to claim 4, comprising no more than 2% tackifier by weight of the dry formulation.

6. The delayed-tack formulation according to claim 1 being essentially free from tackifier.

7. The delayed-tack formulation according to claim 1, wherein the plasticiser is compatible effectively to plasticise the adhesive polymer.

8. A substrate carrying a delayed tack formulation according to claim 1.

9. The substrate according to claim 8, wherein the plasticiser of the delayed-tack formulation is incompatible with a polymeric material of the substrate itself.

10. The substrate according to claim 8, wherein said substrate is a film.

11. The substrate according to claim 10, wherein said film is polypropylene.

12. The substrate according to claim 10 in the form of a reel of film carrying the delayed-tack formulation.

13. The substrate according to claim 8, wherein the delayed tack formulation has been heat-activated.

14. A sealed article or package comprising a substrate according to claim 8.

15. A sealed article or package according to claim 14 in the form of a ream wrap package.

16. An adhesive article or adhesive stock comprising a substrate according to claim 8.

17. An adhesive article or adhesive stock according to claim 16 in the form of a label or labelstock.

18. A label or label stock according to claim 17 further comprising a release liner.

19. A labelled article carrying a label according to claim 17.

20. A method of preparing a substrate carrying a delayed-tack formulation according to claim 8 comprising forming an emulsion of a plasticiser and an adhesive polymer and optionally other ingredients, coating said substrate with said emulsion, and drying the resultant coating below a tack activation temperature.

21. A method of activating a delayed-tack formulation according to claim 1 comprising heating said formulation.
